(19) United States
(12) Patent Application Publication
(10) Pub. No.: US 2007/0101784 A1
(43) Pub. Date: May 10, 2007

(54) Soil improvement material derived from marine resources and process for producing the same

(76) Inventor: Toshiaki Kudoh, Aomori (JP)

Correspondence Address: FAY SHARPE LLP, 1100 SUPERIOR AVENUE, SEVENTH FLOOR, CLEVELAND, OH, 44114, US

(21) Appl. No.: 10/550,403

(22) PCT Filed: Mar. 29, 2004
(86) PCT No.: PCT/JP04/04750

§ 371 Date: Sep. 11, 2006

(30) Foreign Application Priority Data
Mar. 31, 2003 (JP) 2003-093619

(51) Int. Cl. C05D 9/02

(52) U.S. Cl. 71/63

(57) ABSTRACT

A method of manufacturing a soil improvement material (3) utilizing a marine resource (1) in which calcium carbonate is present in such away as to be separated from the matrix, comprising a baking step (P1) of baking the marine resource (1) containing, as main compositions, calcium carbonate and an organic matrix enveloping the calcium carbonate on a baking condition that the baking causes alteration of the organic matrix to an extent that the calcium carbonate can be separated from the organic matrix so as to produce a baked substance (2) and a powdering step (P2) of separating the calcium carbonate in the produced baked substance (2). The soil improvement material (3) acts quickly, does not have any adverse influence on the roots of plants, and enables seeding even on the day when the material (3) is spread.

### TECHNICAL FIELD

The present invention relates to a material for soil improvement derived from marine resources and a process for producing the same, and, in particular, to a fast acting soil improving material derived from marine resources in which calcium carbonate contained in shells can be utilized efficiently and a process for producing the same.

### BACKGROUND ART

At present, calcium carbonate materials are mass produced from a mineral resource, limestone, and its pulverization and utilization have long been established, and analysis and research on its function have been also made for a long time. The limestone products are widely used in the society as agricultural and industrial materials. In contrast, shells as a biological resource have advantages of containing calcium carbonate as a main component at a higher concentration than limestone and less impurities, and possess some better qualities than limestone which is the major source at this time and has an established utility. Calcium carbonate in shells (hereinafter shell calcium carbonate) has been isolated and produced in the past. Conventionally, raw shells are directly pulverized into fine powder which is then used as an agricultural material, in particular as a slow acting fertilizer for improving acidic soil.

Improving acidic soil by shell products has been practiced in the past, and further improved methods have been recently proposed in patent applications and the like. Among them, in Japanese Patent Laid-Open No. 2000-26182, “Lime material for basal fertilizer”, an agricultural lime material, which comprises a lime material derived from shell etc. as main component and an edible organic acid such as citric acid as additive, and convertible to quicklime in soil, has been proposed in order to make a poorly soluble calcium of an agricultural lime material more soluble, thereby supplementing the soil with a small amount of the material, instead of a large amount thereof applied in the past. (Reference 1)

Further, in Japanese Patent Laid-Open No. 2002-125582, “Method for processing oyster shells and the like”, a method has been proposed to make the processing easier that produces a fertilizer or a soil improving agent from oyster shells and the final product quality better, wherein the oyster shells is subjected to a pressure of 2 atm or higher at a temperature of 120 to 150° C. for a predetermined period of time in a humidified or dried atmosphere, the pressure is then reduced to 1 atm in 5 seconds or longer, and then the shells are pulverized. According to this method, it is claimed that the oyster shells and the like become softer by the pressure and heat treatments and may be pulverized easily, and the powder thus obtained has a good quality without sharp edges and can be handled safely (Reference 2).

Lime materials for improving acidic soil include strong alkalis such as quicklime CaO and hydrated lime Ca(OH)₂, not so strong alkalis such as calcium carbonate CaCO₃ and magnesium lime (contains Mg) and powdered shells, which are rich in calcium carbonate but are not utilized sufficiently as described above. The reference 1 described above refers to an art of the efficient elution in converting powdered shells to calcium oxide, while the reference 2 refers to an art of facilitating the pulverization of shells.

Reference 1

Japanese Patent Laid-Open No. 2000-26182. Claims: claim 1-3. Detailed description of the invention: paragraph 0004-0009, paragraph 0014-0021.

Reference 2

Japanese Patent Laid-Open No. 2002-125582. Claims: claim 1-3. Detailed description of the invention: paragraph 0003-0009.

### DISCLOSURE OF THE INVENTION

Limestone calcium carbonate materials currently in use as soil improving agents have characteristics that they do not affect plant roots, but a time lapse of 40 days or longer may be required before they undergo degradation in conjunction with organic materials in soil, and the soil improvement is achieved. Therefore, although almost no danger of damage by lime, there is a shortcoming that their soil improving effect is slow acting. On the other hand, calcium hydroxide (hydrated lime), which is routinely used as a soil improving agent for farm field, requires only a small amount for field spraying because it is a strong alkali but has a shortcoming that field works such as sowing seeds, transplanting seedlings and the like may not be performed for a week or, sometimes, 2-3 weeks after the field spraying due to its strong alkaline nature.

In the field of cold or high altitude areas where workable days in the field per year are limited because of snow and low temperature in the winter, it is desirable to shorten as much as possible the number of days between the lime-spray and the achievement of acid soil improvement. To achieve this purpose, it is more effective to provide an art to accelerate the soil improving effect using calcium carbonate which has little problem of damaging plant roots, rather than to provide approaches described in the background art such as eluting efficiently in converting powdered shells to calcium oxide or facilitating the pulverization of shells. Since shells contain more calcium carbonate than limestone does as described above, it is only necessary to provide an art of converting shell calcium carbonate to a lime material having a fast acting soil improvement effect.

However, shell calcium carbonate exists as ultra fine particles in the organic matrix, which is one of the components of shells, and the particles have a size from about several 100 nm to several μm. Therefore, in the conventional powdered shell materials, which are produced by applying the same method as the method for pulverizing limestone, almost all calcium carbonate is still trapped in the shell organic matrix which are hard to degrade and solubilize, and spraying to soil is carried out in such a condition. Since the shell organic matrix is hardly solubilized or degraded in soil, only a very small amount of calcium carbonate, which accidentally gets out of the structure of the shell organic matrix during the pulverization process, may act on soil improvement. This is the basic reason why the practical applicability and evaluation for the agricultural soil improving material from shells (powdered shells) are so low, and also is the major cause of the lack of the utilization. In another word, the conventional arts can not provide a shell-calcium carbonate based fast acting soil improving material which can extend the number of workable days in the field.

A subject of the present invention is to overcome the shortcomings of the prior arts and to provide a soil improving material which is a fast acting acidic soil improving material derived from marine resources such as shells and the like, and a process for producing the same. Another subject of the present invention is to provide a process for producing the soil improving material derived from marine resources which may be able to utilize shell calcium carbonate with a high efficiency. Still another subject of the present invention is to provide a soil improving material derived from marine resources which is not damaging to plant roots and permits sowing seeds on the same day of the field spraying.

The present inventors, earnestly studying about the subjects described above, have accomplished the subjects. The present invention disclosed in the present application as the means for accomplishment of the subjects comprises the following items.

(1) A method for producing a soil improving material derived from marine resources, wherein the soil improving material comprises calcium carbonate existing separately from organic matrix, comprising the steps of:

burning marine resources, under burning conditions for degrading the organic matrix to such an extent that calcium carbonate may be separated from the organic matrix, the marine resources comprising calcium carbonate and organic matrix enclosing calcium carbonate as main components, and

pulverizing the burnt material obtained in the burning step to separate calcium carbonate therein.

(2) The method for producing a soil improving material derived from marine resources according to (1), characterized in that the marine resources are shells of scallops, oysters, corbiculas and the like shellfish.

(3) The method for producing a soil improving material derived from marine resources according to (1) or (2), characterized in that the burning step is carried out under burning conditions for carbonizing the organic matrix, and in the burning step, a burnt material, which consists of undegraded calcium carbonate and carbonized organic matrix, may be obtained.

(4) The method for producing a soil improving material derived from marine resources according to (3), characterized in that the burning conditions comprises a burning temperature from 560° C. to 740° C., and a burning time from 3 minutes to 25 minutes.

(5) The method for producing a soil improving material derived from marine resources according to (3), characterized in that the burning conditions comprises a burning temperature from 600° C. to 700° C., and a burning time from 5 minutes to 20 minutes.

(6) The method for producing the soil improving material derived from marine resources according to (1) or (2), characterized in that the burning step is carried out under burning conditions for ashing the organic matrix, and in the burning step, a burnt material, which consists of undegraded calcium carbonate and ashed organic matrix, may be obtained.

(7) The method for producing a soil improving material derived from marine resources according to (6), characterized in that the burning conditions comprises a burning temperature from 720° C. to 900° C., and a burning time from 25 minutes to 45 minutes.

(8) The method for producing a soil improving material derived from marine resources according to (6), characterized in that the burning conditions comprises a burning temperature from 750° C. to 850° C., and a burning time from 25 minutes to 45 minutes.

(9) The method for producing a soil improving material derived from marine resources according to (6), characterized in that the burning conditions comprises a burning temperature from 770° C. to 830° C., and a burning time from 25 minutes to 45 minutes.

(10) The method for producing a soil improving material derived from marine resources according to any of (6)-(9), characterized in that the burning step comprises use of a fuel and a furnace which are together capable of degrading calcium oxide generated in the step.

(11) The method for producing a soil improving material derived from marine resources according to (10), characterized in that the fuel is natural gas and the furnace is a radiant heat furnace.

(12) The method for producing a soil improving material derived from marine resources according to any of (1)-(11), characterized in that the pulverizing step comprises crushing the burnt material mechanically and passing the resultant crashed material through a wire sieve of mesh size from 60 (250 μm) to 80 (177 μm).

(13) A soil improving material derived from marine resources, characterized in that the soil improving material is produced by burning a raw material, and contains calcium carbonate of 98% by weight or more and alkali content from 50% to 60%, wherein the raw material is shells of scallops, oysters, corbiculas or the like shellfish containing calcium carbonate and organic matrix enclosing calcium carbonate as main components.

(14) A soil improving material derived from marine resources produced by the method according to any of (2)-(12), characterized in that the soil improving material contains calcium carbonate 98% by weight or more and alkali content from 50% to 60%.

(15) A soil improving material derived from marine resources, which is produced by burning a raw material of shells of scallops, oysters, corbiculas and the like shellfish containing calcium carbonate and organic matrix enclosing calcium carbonate as main components, characterized in that particles with a diameter of 250 μm or less represents 90 to 100% by weight of the total weight.

(16) A soil improving material derived from marine resources produced by the method according to any of (2)-(12), characterized in that particles with a diameter of 250 μm or less represents 90 to 100% by weight of the total weight.

Having noticed that shells that are marine resources contain high concentration of calcium carbonate, which is a lime material for improving acidic soil without damaging plant roots, but not utilized sufficiently in the past, the present application provides an art which allows efficient utilization of shells, as well as a fast acting acid soil improving material without the danger of damaging plant roots, and a process for producing the same.

Further, the present application provides a new and useful soil improving material based on advantageous function and capacity provided by ultra-fine particle nature of shell calcium carbonate, which are quite different from those provided by conventional calcium carbonate derived from limestone, and also explanation for the application, utilization and advantages.

In the present application, shells are mentioned in particular as marine resources as a row material for the soil improving material derived from marine resources of the present invention, but the present invention is not limited to shells. Any known resources, which contain sufficient amount of calcium carbonate, and to which the process for production of the present invention may be applicable, may be the raw material marine resources of the present invention. For example shells of sea urchin, fish bones and the like are included, and shells of scallop, oyster, corbiculas and all other shellfish are also included. Since the soil improving material derived from marine resources in the present invention has a function also as a calcium carbonate agent for improving acidic soil, the words “soil improving agent” are used fittingly in the text.

Calcium carbonate composing shells (referring to a substance composed of calcium carbonate, and will be hereinafter used for this meaning as needed) is hard to degrade, hard to solubilize and is enclosed in hard shell organic matrix. The shell organic matrix are like walls separating a block of calcium carbonate from the next block. The matrix may be visualized as a concrete block, the concrete part of which corresponds to a shell organic matrix, and ultra-fine particles of calcium carbonate are hidden in the empty space of the block. These two shell components, “calcium carbonate” and “shell organic matrix”, undergo quite different types of degradation at the burning temperature. When heated at higher than 900° C., it is known that calcium carbonate is degraded, loses carbon dioxide and generates calcium oxide. On the other hand, in the shell organic matrix, carbonizing starts at 560° C. and ashing start slowly at above 700° C. Based on such a difference in degradation, it is possible to separate calcium carbonate from the shell organic matrix by subjecting shells to burning treatment for carbonizing and ashing. Also, since the shell organic matrix becomes softer after the burning treatment for carbonizing and ashing, the pulverization for separation and extraction becomes easier.

The separation and extraction of calcium carbonate and shell organic matrix are carried out by mechanically pulverizing the burnt shells into fine powder. In particular, the shell organic matrix subjected to burning treatment for complete ashing tend to lose the hardness, are completely degenerated and pulverized into fine powder in natural environment without special treatment. The shell powder particle may be in the level of passing through wire sieves of 60 mesh (250 μm)-80 (177 μm) mesh taking into the consideration the fast soil improving effect in the field and the practical applicability as an agricultural material in spray work.

As described above, the limestone calcium carbonate material, which has been playing a central role as a soil improving agent, is characterized in that it does not affect plant roots, but it takes 40 days or longer before soil improving effect is achieved, and in the case of calcium hydroxide (hydrated lime), field works such as sowing, transplanting seedlings and the like may not be carried out for one week or longer after spraying. However, since shell calcium carbonate, in which the shell organic matrix are carbonized or ashed according to the present invention, can carry out fast soil improvement without affecting plant roots, there is no need for stopping field work like in the past.

The reason why such an advantage of the present invention is obtained is because it is thought that the mutual degrading reaction between the shell calcium carbonate in ultra-fine particles (hereinafter also “ultra-fine particle shell calcium carbonate”) and organic compounds proceeds fast, and soil improvement is quickly achieved without damaging plant roots. Thus, a great soil improving effect is already seen on the next day of spraying and mixing into soil, and field works such as sowing, transplanting seedlings and the like may be performed because it has a characteristic of not damaging to plant roots. Since shell calcium carbonate does not impose any limitation on field works after it is sprayed, the number of days for field utilization is extended, and for the fields in cold areas or in high altitude and cold areas, it is a soil improving agent of great effect on extending the field working days.

### BRIEF DESCRIPTION OF THE DRAWINGS

FIG. 1 is a flow chart showing the composition of the process for producing of the soil improving material derived from marine resources according to the present invention;

FIG. 2 is a flow chart showing the composition of the process for producing of the soil improving material derived from marine resources including the carbonizing step;

FIG. 3 is a flow chart showing the composition of the process for producing of the soil improving material derived from marine resources including the ashing step;

FIG. 4 is a photograph showing the growth of a kind of Chinese cabbage (Brassica Rapa var. pervidis) at the last day of the test grown in soil mixed with carbonated shell calcium carbonate; and

FIG. 5 is a photograph showing the growth of a kind of Chinese cabbage (Brassica Rapa var. pervidis) at the last day of the test grown in control soil not mixed with carbonated shell calcium carbonate.

Each symbol is used as follows.

1 . . . marine resources (raw materials), 2 . . . burnt material (organic matrix degraded), 3, 33, 63 . . . soil improving material, 32 . . . burnt material (organic matrix carbonized), 62 . . . burnt material (organic matrix ashed), P1 . . . burning step, P2, P32, P62 . . . pulverizing step, P31 . . . carbonizating step, P61 . . . ashing step.

### BEST MODE FOR CARRYING OUT THE INVENTION

Next, the present invention will be described in detail with reference to figures.

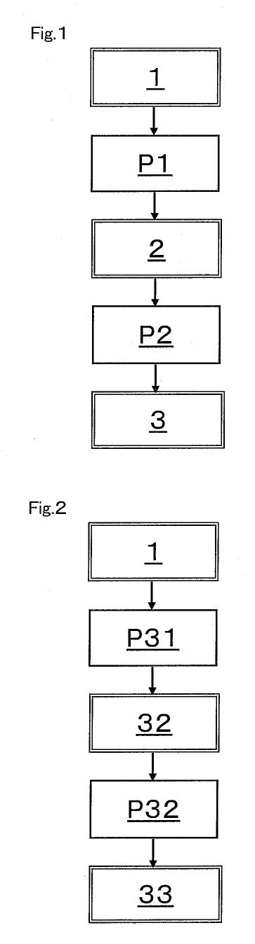

FIG. 1 is a flow chart showing the composition of the process for producing of the soil improving material derived from marine resources according to the present invention. In the figure, the method for the production in the present invention comprises the burning step P1 to obtain the burnt material 2 of marine resources 1, which contain calcium carbonate and organic matrix enclosing calcium carbonate as main components, under burning conditions under which the organic matrix are degraded to such an extent that calcium carbonate may be separated from the organic matrix, and the pulverizing step P2 to separate calcium carbonate in the burnt material 2 which is obtained in this burning step P1, and by going through each step, finally the soil improving material derived from marine resources 3, in which calcium carbonate exists separately from the organic matrix, may be obtained. Examples of marine resources subjected to the process of the present invention (as raw materials) include shells of scallops, oysters, corbiculas and the like shellfish.

Since the present method for production comprises the steps as described above in FIG. 1, marine resources 1, which contain calcium carbonate and organic matrix enclosing calcium carbonate as main components, are burnt in the burning step P1 with a suitable burning conditions to obtain the burnt material 2 in which the organic matrix are degraded to such an extent that calcium carbonate may be separated from the organic matrix, and then in the pulverizing step P2, the burnt material 2, which is obtained in the burning step P1, is pulverized to separate calcium carbonate, and finally the soil improving material derived from marine resources 3 is obtained in which calcium carbonate exists separately from the organic matrix.

FIG. 2 is a flow chart showing the process for producing the soil improving material derived from marine resources wherein the composition includes the carbonizing step. In the figure, the method for production in the present invention comprises the burning step described above, in particular the carbonizing step P31, which is carried out under the burning conditions capable of carbonizing the organic matrix described above. By this step P31, the burnt product 32 comprising undegraded calcium carbonate and carbonized organic matrix may be obtained, and finally obtained is the soil improving material derived from marine resources 3 in which calcium carbonate exists separately from the organic matrix.

In the figure, the burning conditions described above may be that the burning temperature is preferably 560° C. or above and 740° C. or below, and the burning time is for 3 minutes or longer and for 25 minutes or shorter, or, more preferably, the burning temperature is 600° C. or above and 700° C. or below, and the burning time is for 5 minutes or longer and for 20 minutes or shorter. The carbonizing of the, shell organic matrix to separate enclosed calcium carbonate may be carried out by setting the condition in this way.

The carbonizing step P31 will be described in more detail.

Shells consist of “calcium carbonate” and “shell organic matrix”. It is reported that shells contain 90-92% of calcium carbonate and 10% of shell organic matrix or less. In the step P31 of the present invention, the shell organic matrix are burnt for facilitating separation and extraction of fine particulate calcium carbonate enclosed in the organic matrix. The carbonizing temperature is, preferably, burning temperature of 560° C. or above and 740° C. or below, and the burning time is for 3 minutes or longer and for 25 minutes or shorter, or, more preferably, the burning temperature is 600° C. or above and 700° C. or less, and the burning time is for 5 minutes or longer and for 20 minutes or shorter. When calcium carbonate is heated at 900° C. or above, carbon dioxide CO₂ is released and calcium oxide CaO (quicklime) is generated. Thus, under the temperature condition described above, calcium oxide generation is suppressed and shell calcium carbonate is maintained almost at the original level. Furthermore, the hardness of the shell organic matrix which have made pulverization difficult is reduced greatly by this carbonizing step P31. The carbonized sites of the shell organic matrix are so soft that pulverization and further formation of fine powder become easy, and this can facilitate the separation and extraction of calcium carbonate in the following step, that is the pulverization step P32.

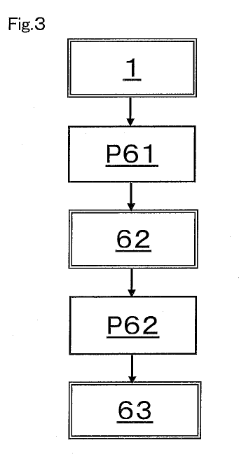

FIG. 3 is a flow chart showing the process for producing the soil improving material derived from marine resources wherein the composition includes the ashing step. In the figure, the method for the production of the present invention comprises the burning step, in particular the ashing step P61 which is carried out under the burning conditions that the organic matrix may be ashed. By this step P61, a burnt material 62 consisting of undegraded calcium carbonate and ashed organic matrix can be obtained, and finally the soil improving material derived from marine resources 63 in which calcium carbonate exists separately from organic matrix can be obtained.

In the figure, the burning conditions described above may be that the burning temperature is 720° C. or above and 900° C. or below, and the burning time is for 25 minutes or longer and for 45 minutes or shorter, or, preferably, the burning temperature is 750° C. or above and 850° C. or below, and the burning time is for 25 minutes or longer and for 45 minutes or shorter, or more preferably, the burning temperature is 770° C. or above and 830° C. or below, and the burning time is for 25 minutes or longer and for 45 minutes or shorter. The ashing of the shell organic matrix to separate enclosed calcium carbonate may be carried out by setting the condition in this way.

The ashing step P61 is explained in more detail.

To make the separation between the two components of shells, “calcium carbonate” and “shell organic matrix” surer and much larger, in the step P61 of the present invention the burning temperature is raised so that shell organic matrix are converted to ash which is the further advanced stage of carbonizing. Hardness of the ashed shell organic matrix is completely degenerated. Shells subjected to ashing have a characteristic of being pulverized and, after a certain period of time, becoming fine powder under the natural environment outside the furnace without any specific treatment.

To subject the shell organic matrix to ashing while maintaining calcium carbonate as it is, shells are burnt by keeping the temperature at about 800° C. for 30-35 minutes. In this condition, the level of ashing is 98% or above. However, there is a possibility that a small portion of fine particle calcium carbonate loses carbon dioxide CO₂, and calcium oxide CaO is generated. To avoid this to happen, it is more preferable to use a radiant heat furnace using natural gas fuel in the ashing step P61. This type of furnace is characterized in that shells are not exposed directly to the combustion flame. Furthermore in the combustion reaction of natural gas with oxygen in air, heat energy, carbon dioxide CO₂ and steam H₂O are generated. These characteristics of natural gas combustion and the radiant heat furnace are utilized to the maximum.

That is, using the heat energy as energy for heating the radiant heat furnace, the generated steam is recombined with calcium oxide formed in the furnace in the step P61 to convert calcium oxide CaO to calcium hydroxide Ca(OH)₂. Thus, by carrying out the ashing treatment of the shell organic matrix in the radiant heat furnace using natural gas fuel, calcium oxide component generated in the heating step may be degraded and removed by the chemical reaction using the combustion characteristics.

Because the structure of the shell organic matrix subjected to ashing are degenerated, they become fine powder with passing time under the natural environment without any specific treatment, and at the later step of the pulverizing step P62, the separation and extraction of calcium carbonate and the shell organic matrix may be carried out easily and surely. The generated amount of calcium hydroxide, to which calcium oxide, a byproduct of high temperature heating, is converted, is 16-18% by weight when the shell organic matrix are almost totally undergone ashing.

The pulverizing step P2, P32 and P62 in FIG. 1, 2 and 3, respectively, may be the step of pulverizing the burnt material described above mechanically and passing the obtained pulverized materials through wire sieves of 60 mesh (250 μm) or 80 mesh (177 μm).

Next, the pulverizing step P2, P32 and P62 is explained in detail.

After the carbonizing step P31 in FIG. 2, the carbonized shells are subjected to mechanical pulverization to make sure the extraction of fine particle calcium carbonate from inside of the shell organic matrix. After carbonizing, the shell organic matrix lose their resistance to pulverization, and the softened shells are easily pulverized into fine powder. The fine powder is passed through a wire sieve of 60 mesh (250 μm)-80 mesh (177 μm). The shell calcium carbonate in the particle level obtained in this way is well exposed on the surface with a sufficient soil improving function. Furthermore, even in the windy field, the spray work may be carried out with a similar practical utility as conventional materials.

After the carbonizing step P61 in FIG. 3, the shell organic matrix are subjected to complete ashing, and the hardness of shells is lost. Shells having a deteriorated structure of the shell organic matrix form cracks spontaneously under the natural environment outside the furnace without any special treatment. The cracks spread over the whole shells and degrades the shell structure, and later pulverization starts and proceeds to such a stage where about 95% of the whole may pass through a 60 mesh wire sieve after about a month. However, it is more preferable to perform mechanical pulverization to make sure the separation and extraction of calcium carbonate. In the step P62, the fine powder may be passed through a wire sieve of 60 mesh (250 μm)-80 mesh (177 μm). In the spray work in the field, it may be handled in a similar way as the carbonized fine powdered calcium carbonate. The soil improving function is also equivalent to that of the carbonized material and the amount of spray may be kept lower.

Using the method for production in the present invention explained as above, the soil improving material derived from marine resources may be obtained which is characterized in that it contains 98% by weight of calcium carbonate or above, and alkali component of 50% by weight or above and 60% by weight or below, using shells of scallops, oysters, corbiculas and the like shellfish as raw materials. Also, the soil improving material derived from marine resources may be obtained which is characterized in that the particles with diameter of 250 μm or below are 90% by weight or above or 100% by weight or below of the whole, using shells of scallops, oysters, corbiculas and the like shellfish as raw materials.

Calcium carbonate preparations obtained by carbonizing or ashing the shell organic matrix may be handled in the same way. After sprayed in the field, ultra-fine particles of shell calcium carbonate starts self-degradation due to the fast degradation interactive with organic substances in soil. Soil fertilization by degradation of organic substances and soil improvement by the degradation of calcium carbonate proceed at the same time. This fast acting efficacy is the greatest feature of the ultra-fine particle calcium carbonate which is contained in shells that are a bio-resource.

Also, it is known that calcium carbonate has a merit of not injurious to plant roots. This is because calcium carbonate does not generate heat in soil like quicklime CaO does and does not have a drastic ion-exchange action like hydrated lime Ca(OH)₂ does. After spraying shell calcium carbonate which has been subjected to carbonizing or ashing, sowing seeds and transplanting of seedlings may be carried out on the same day. This is the greatest advantage of the ultra-fine particle shell calcium carbonate which is the soil improving material derived from marine resources of the present invention.

The official specifications for calcium carbonate produced from limestone are that all of the particles should pass through a 1.7 mm wire sieve and 85% or more should pass through a 600 μm (30 mesh) wire sieve. After spraying this calcium carbonate over soil, soil improving effect is obtained after 40 days or later. When compared to the particle size of shell calcium carbonate, the size of this calcium carbonate is about 1000 times larger. Even after a few months of the spraying, un-degraded particles of calcium carbonate according to the official specification may be seen in soil. However, the shell calcium carbonate of the soil improving material derived from marine resources according to the present invention consists of ultra-fine particles with a size 1/1000 of the official specification described above, and therefore such unused materials can be reduced markedly. In particular, the production method of the present invention, by which the material is subjected to the ashing treatment, has a high efficiency of extraction of ultra-fine particle calcium carbonate.

The fine powdered shell calcium carbonate, which has undergone carbonizing or ashing treatment, does not restrict field works. In cold areas such as Tohoku, Hokkaido and the like or cold high altitude areas, cultivation time in the field is limited by the seasonal factor that is the winter. For such areas, expanding cultivation time and extension of field utilization time may be realized.

### Embodiments

Embodiments of the present invention will be described below, but the soil improving material derived from marine resources of the present invention and the method for producing the same are, of course, not limited by them.

### Embodiment 1: Carbonizing Treatment of Shells

To separate and extract fine particulate calcium carbonate enclosed in the shell organic matrix, a test for carbonizing treatment of the shell organic matrix is carried out. Shells of scallops are treated in a burning furnace, Super-Kiln PSK type (made by Japan Kiln Co.), at a carbonizing temperature of 600° C.-700° C. for 20 minutes-5 minutes to prevent the generation of calcium oxide (it is known that calcium carbonate CaCO₃, when heated at 900° C. or above, loses carbon dioxide CO₂ and generates calcium oxide CaO.). Test results of the burnt material thus obtained are as follows.

Calcium carbonate 98.43%

Alkali content54.42%

pH 10.2 (Assay Organization:
Japan Fertilizer and Feed
Inspection Association)

The components of shells are calcium carbonate and the shell organic matrix. It has been reported that the contents of calcium carbonate and the shell organic matrix in shells are 90-92% and 10% or less, respectively. Thus, most of the shell calcium carbonate was found to be kept after the carbonizing treatment of the present invention. Furthermore, by this carbonizing treatment, the hardness of the shell organic matrix, which makes the pulverization difficult, is reduced greatly. The carbonized sites of the totally softened shell organic matrix are in the condition permitting pulverization and powder formation and makes separation and extraction of calcium carbonate sufficiently possible.

### Embodiment 2: Ashing Treatment of Shells

To separate “calcium carbonate” and “shell organic matrix”, which compose shells, more distinctly and more securely, a test for ashing was carried out, in which the shell organic matrix are ashed rather than carbonized by burning at a higher temperature. Shells of scallops are heated in the same furnace as the one used in the embodiment 1, keeping the temperature around 800° C. for 30-35 minutes for ashing treatment while maintaining calcium carbonate level. Also, the burning is carried out using natural gas fuel in radiant heat type furnace to convert calcium oxide CaO, which is generated in a small quantity at the high temperature, to calcium hydroxide Ca(OH)₂.

Test results of the burnt material thus obtained are as follows.

Calcium carbonate 73.91%

Alkali content61.03%

pH 12.1 (Assay Organization: Japan Fertilizer and Feed Inspection Association)

The ashing level was found 98% or above. The shell organic matrix subjected to ashing lost the hardness completely, the structure of which was degenerated. The ashed shells were spontaneously being broken and after a while pulverized into fine powder when they were exposed to open air outside the furnace. Thus, in this the condition, the separation and extraction of calcium carbonate from the shell organic matrix are easily and surly achieved. The amount of calcium hydroxide generated is, when almost all the shell organic matrix are subjected to ashing, 16-18% by weight.

Table 1 summarizes the evaluation of shell degeneration and pulverization in each burning treatment test for carbonizing and ashing.

TABLE 1
Burning test for scallop shells

| TEMPERATURE | OBSERVATION OF | EVALUATION OF |
|---|---|---|
| (° C.) | DEGENERATION | PULVERIZATION |
| 600 | Totally carbonized | |
| 700 | The surface slightly | Easily broken by |
| | ash-white | the hand |
| 800 | Whole surface ashed | Pulverized into |
| | | powder under the |
| | | natural environment |

### Embodiment 3: Soil Improving Test of Soil Improving Agent Made From Carbonized Shells

A soil improving agent made from carbonized shells (hereinafter “carbonized sell calcium carbonate”) is tested for acidic soil improving effect. The specifications for the test are as follows. Hereinafter shells used as raw materials are scallop shells unless otherwise stated.

Preparation of test sample: soil and carbonized shell calcium carbonate are mixed as follows.

Sample a: Red clay (flat land)+carbonized shell calcium carbonate 2 g.

Sample b: Red clay (flat land)+carbonized shell calcium carbonate 2 g+fermented fowl droppings 200 g.

Sample c: Red clay (mountain, fresh)+carbonized shell calcium carbonate 2 g+fermented fowl droppings 200 g.

Sample d: Black soil (field)+carbonized shell calcium carbonate 2 g+fermented fowl droppings 200 g.

Test container: mini planters 0.13 m×0.26 m×0.10 m (volume 0.0338 m³)

Red clay collected at: Shinjo-district, Aomori City, Aomori Prefecture, Black soil collected at: Ariura-district, Ohdate City, Akita Prefecture, Test site: sample a is tested indoor, samples b, c, d are tested outdoor.

Watering: sample a is not watered, sample b, c, and d are watered.

Measuring instrument: pH meter WM-22EP (DKK TOA Corporation)

Results are shown in Table 2.

TABLE 2

| | SAMPLE A | SAMPLE B | SAMPLE C | SAMPLE D |
|---|---|---|---|---|
| Original | 6.00 pH | 6.00 pH | 5.63 pH | 5.46 pH |
| soil pH | | | | |
| Day 2 of | 6.73 | 6.85 | 6.41 | 6.43 |
| Mixing | | | | |
| Day 3 | 6.98 | 6.86 | 6.4 | 6.64 |
| Day 4 | 6.72 | 6.73 | 6.23 | 6.28 |
| Day 5 | 6.68 | 6.63 | 6.49 | 6.43 |
| Day 6 | 6.71 | 6.85 | 6.57 | 6.90 |
| Day 7 | 6.82 | 6.66 | 6.47 | 6.45 |
| Day 14 | 6.77 | 6.71 | 6.59 | 6.66 |
| Day 25 | 6.89 | 6.84 | 6.77 | 6.97 |
| Day 45 | 6.79 | 6.52 | 6.61 | 6.44 |
| Day 55 | 6.94 | 6.73 | 6.61 | 6.53 |
| Day 65 | 6.88 | 6.71 | 6.58 | 6.40 |
| Day 75 | 6.83 | 6.71 | 6.69 | 6.32 |
| Day 85 | 6.78 | 6.74 | 6.35 | 6.57 |
| Day 95 | 6.88 | 6.77 | 6.71 | 6.45 |
| Day 115 | 6.67 | 6.67 | 6.77 | 6.55 |

As shown in the table, the soil in each test group with pH range 5.4-6.0 is improved so fast and sufficiently that the pH becomes 6.4-6.8 at day 2 of the mixing, that is next day of mixing the soil with carbonized calcium carbonate, and after that the level is maintained almost at the same level for 115 days. Thus, it is demonstrated that the carbonized shell calcium carbonate of the present invention has a fast acting acid soil improving effect.

### Embodiment 4: Soil Improving Test of Soil Improving Agent Made From Ashed Shells

A soil improving agent made from ashed shells (herein after “ashed shell calcium carbonate”) is tested for acidic soil improving effect. The specifications for the test are as follows.

Preparation of test sample: soil and carbonized shell calcium carbonate are mixed as follows.

Sample a: Red clay (flat land)+ashed shell calcium carbonate 2 g+fermented fowl droppings 200 g.

Sample b: Red clay (mountain, fresh)+ashed shell calcium carbonate 2 g+fermented fowl droppings 200 g.

Sample c: Black soil (field)+ashed shell calcium carbonate 2 g+fermented fowl droppings 200 g.

Test container: mini planters 0.13 m×0.26 m×0.10 m (volume 0.0338 m³)

Red clay collected at: Shinjo-district, Aomori City, Aomori Prefecture, Black soil collected at: Ariura-district, Ohdate City, Akita Prefecture, Test site: samples a, b, and c are all tested outdoor.

Watering: sample a, b and c are watered.

Measuring instrument: pH meter WM-22EP (DKK TOA Corporation)

Results are shown in Table 3.

TABLE 3

| | SAMPLE A | SAMPLE B | SAMPLE C |
|---|---|---|---|
| Original soil pH | 6.11 pH | 6.03 pH | 6.00 pH |
| Day 2 of Mixing | 7.66 | 7.08 | 6.78 |
| Day 3 | 7.65 | 7.43 | 6.88 |
| Day 4 | 7.58 | 7.48 | 6.90 |
| Day 5 | 7.62 | 7.63 | 6.88 |
| Day 6 | 7.54 | 7.45 | 6.95 |
| Day 7 | 7.63 | 7.6 | 7.10 |
| Day 14 | 7.58 | 7.49 | 7.17 |
| Day 25 | 7.64 | 7.4 | 7.17 |
| Day 35 | 7.49 | 7.38 | 7.21 |
| Day 45 | 7.44 | 7.41 | 7.30 |
| Day 55 | 7.68 | 7.69 | 7.37 |

As shown in the table, the soil in each test group with pH range 6.0-6.1 (data in the table are rounded up at the first decimal place, hereinafter the same) is improved so fast and sufficiently that the pH reaches 6.8-7.7 at day 2 of the mixing, that is next day of mixing the soil with ashed shell calcium carbonate. In the sample a, the level is maintained almost at the same level for 55 days and in the test sample b and c, tend to increase slowly. Thus, it is demonstrated that the ashed shell calcium carbonate of the present invention has a fast acting acid soil improving effect in any test group.

### Embodiment 5: Cultivation Test With Carbonized Shell Calcium Carbonate (1)

The effect of spraying carbonized shell calcium carbonate in soil on the cultivation of a crop is tested. The specifications for the test are as follows.

Test crop: spinach, variety, Western big leaf (Hamburg)

Test site: Kuchiba district, Koyanagi, Aomori City.

Test area: 1.90m×0.70 m, 1.33 m².

Amount mixed into soil: 150 g

Test period: Aug. 21, 2002-Nov. 20, 2002.

Date of spraying: Aug. 25, 2002.

Date of sowing: Aug. 25, 2002

Table 4 shows the work schedule and the record of growth of this test. “Mineral lime” in the table is the shell calcium carbonate of the present invention.

TABLE 4

| DATE | WORK RECORD AND GROWTH RECORD |
|---|---|
| August 21 | Soil pH at the test field before work starts: |
| | pH 7.17 |
| | Fermented fowl droppings 3 kg and dried |
| | fowl droppings 1 kg are mixed with soil |
| | and tilled |
| August 24 | Seeds of spinach are soaked in water |
| August 25 | Mineral lime 150 g is mixed with soil and |
| | sowing is carried out Soil pH after mixing |
| | of fowl droppings and before mixing of |
| | lime pH 6.82 |
| August 26 | After mixing lime pH 7.56 |
| September 1 | Sprouting in full activity. However, |
| | temperature is high |
| September 2 | Sprouting and growth are difficult at air |
| | temperature of 30° C. |
| September 5 | Since the temperature in the morning and |
| | the evening is getting lower, new sprouts |
| | look fresh |
| September 9 | Crop height: the tallest is 4.4 cm |
| | The pH of the test field soil: 7.51. |
| | Remove weeds such as chick weed and the |
| | like |
| September 11 | Recently the air temperature is 25° C., |
| | good weather continues, and the growth |
| | is satisfactory |
| September 18 | Rain continues, and the growth is |
| | satisfactory |
| September 20 | Crop growth observation (3 individuals) |
| | (1) 20.0 cm (2) 19.0 cm (3) 13.2 cm |
| | The pH of the test field soil: 7.73 |
| September 28 | The first harvest. 5 crops 25-28 cm |
| September 30 | Crop growth observation (1) 29.9 cm |
| | (2) 24.4 cm (3) 26.3 cm |
| | The pH of the test field soil: 7.51 |
| October 10 | Crop growth observation (1)39.6 cm |
| | (2)29.9 cm (3)30.1 cm |
| | The pH of the test field soil: 7.59 |
| October 20 | Crop growth observation (1)41.0 cm |
| | (2)30.5 cm (3)31.9 cm |
| | The pH of the test field soil: 7.66 |
| November 9 | The first snow on November 9 (about |
| | 5 cm snow on the morning of November |
| | 10) The pH of the test field soil: 7.63 |

As shown in the table, spinach seeds are sown on the same day of mixing carbonized shell calcium carbonate to soil, but there is no particular problem for the growth of spinach, and the spinach grows equally or better than in normal culture condition. Results of this test indicate that shell calcium carbonate in the soil improving agent of the present invention can improve acidic soil fast and at the same time, does not cause any trouble such as damaging the roots of cultivating crops, even if the vegetable seeds are sown on the same day.

### Embodiment 6: Cultivation Test With Carbonized Shell Calcium Carbonate (2)

The effect of spraying carbonized shell calcium carbonate in soil on the cultivation of a crop is tested. The specifications for the test are as follows.

Test crop: Komatsuna, a kind of Chinese cabbage, Brassica Rapa var. perydis.

Test site: Kuchiba district, Koyanagi, Aomori City.

Test area: 1.30m×0.60 m, 0.78 m².

Amount mixed into soil: 100 g

Test period: Aug. 21, 2002-Nov. 20, 2002.

Date of spraying: Sep. 1, 2002.

Date of sowing: Sep. 1, 2002.

Table 5 shows the work schedule and the record of growth of this test. “Mineral lime” in the table is the shell calcium carbonate of the present invention.

TABLE 5

| DATE | WORK RECORD AND GROWTH RECORD |
|---|---|
| August 21 | Soil pH at the test field before work starts: |
| | pH 7.2 |
| | Fermented fowl droppings 2 kg and dried |
| | fowl droppings 1 kg are mixed with soil |
| | and tilled |
| September 1 | Mineral lime 100 g is mixed with soil. Sowing |
| | is carried out pH of the test field soil after |
| | mixing of fowl droppings: pH 6.89 |
| September 2 | pH of the test field soil after mixing of lime: |
| | pH 7.27 |
| September 3 | Sprouting starts |
| September 5 | Good sprouting condition. Almost all sprouted |
| September 9 | Remove weeds such as chick weeds |
| | pH of the test field soil: 7.31 |
| September 20 | Crop growth observation (3 individuals. |
| | Hereinafter the same.) |
| | (1) 13.5 cm (2) 14.6 cm (3) 18.6 cm |
| | The pH of the test field soil: 7.29 |
| September 26 | The first harvest combined with thinning. |
| | The biggest one is 28.5 cm |
| September 27 | The second harvest combined with thinning |
| September 29 | The third harvest combined with thinning |
| September 30 | Crop growth observation (1) 29.1 cm (2) |
| | 30.6 cm (3) 28.9 cm |
| | pH of the test field soil: 7.40 |
| October 10 | Crop growth observation (1) 38.0 cm (2) |
| | 38.2 cm (3) 42.1 cm |
| | pH of the test field soil: 7.54 |
| October 20 | Crop growth observation (1) 45.1 cm (2) |
| | 45.0 cm (3) 45.4 cm |
| | pH of the test field soil: 7.39 |
| October 30 | Crop growth observation (1)46.2 cm |
| | (2)46.0 cm (3)46.3 cm |
| | pH of the test field soil: 7.38 |
| November 20 | The first snow on November 9 (about 5 |
| | cm snow on the morning of November 10) |
| | Crop growth observation (1)47.2 cm |
| | (2)46.9 cm (3)47.4 cm |
| | pH of the test field soil: 7.44 |

As shown in the table, Komatsuna seeds are sown on the same day of mixing carbonized shell calcium carbonate to soil, but there is no particular problem for the growth of Komatsuna, and the Komatsuna grows equally or better than in normal culture condition. Results of this test indicate that shell calcium carbonate in the soil improving agent of the present invention can improve acidic soil fast and, at the same time, does not cause any trouble such as damaging the roots of cultivating crops, even if the vegetable seeds are sown on the same day, and, furthermore, has promoting effects on growth and development of plants.

### Embodiment 7: Cultivation Test With Carbonized Shell Calcium Carbonate (3)

The effect of spraying carbonized shell calcium carbonate in soil on the cultivation of a crop is tested. The specifications for the test are as follows.

Test crop: Komatsuna, a kind of Chinese cabbage, Brassica Rapa var. perydis.

Test site: Kuchiba district, Koyanagi, Aomori City.

Test container: mini planters 0.13 m×0.26 m×0.10 m (volume 0.0338 m³)

Test area: 1.30 m×0.60 m 0.78 m².

Amount mixed with soil: 2 g.

Test period: Nov. 2, 2002-Feb. 20, 2003.

Date of spraying: Nov. 2, 2002.

Date of sowing: Nov. 2, 2002.

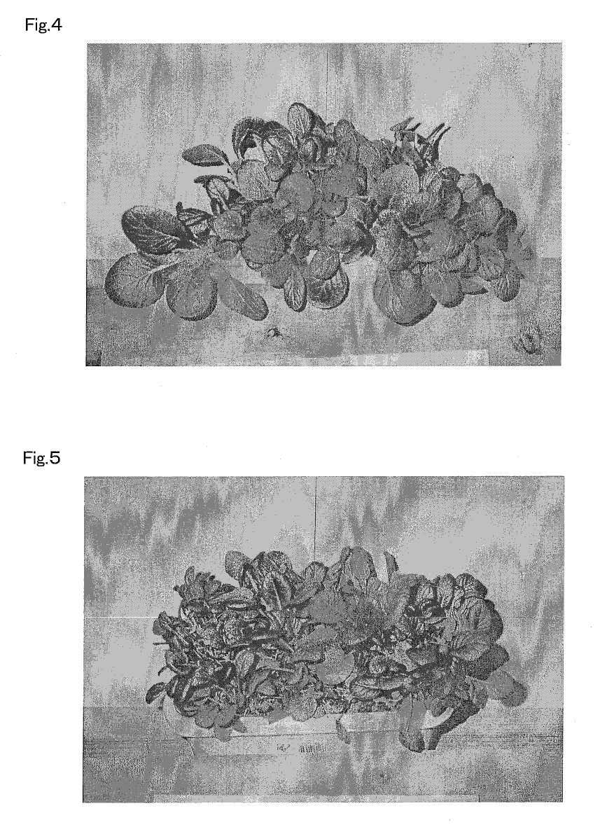

FIG. 4 is a photograph showing the growth of Komatsuna on the last day of the test, cultivated in the soil mixed with carbonized shell calcium carbonate.

FIG. 5 is a photograph showing the growth of Komatsuna on the last day of the test, cultivated in the soil without carbonized shell calcium carbonate being mixed.

Results of the tests shown in FIG. 4 and 5 again indicate that shell calcium carbonate in the soil improving agent of the present invention does not cause any trouble such as damaging the roots of cultivating crops, even if the vegetable seeds are sown on the same day, and, furthermore, has promoting effects on growth and development of plants, such as the height of the plant and the size of leaves.

### Embodiment 8: Cultivation Test With Shell Calcium Carbonate (4)

In other crop cultivation tests described below, it has been confirmed that when shell calcium carbonate in the soil improving agent of the present invention is sprayed as a basal fertilizer and seeds are sown on the same day, there is no ill effect on the plant body in cultivation and the plant grows well. The effect on cultivation worth recording is shown in the parenthesis.

(I) Green vegetables: Chinese cabbage (increase in harvest), bok choy (good growth, good taste).

(II) Legumes and grains: green soy beans (good growth, firm textured bean, good taste), cow pea (increase in harvest), red bean (increase in harvest), corn (firm textured grain).

(III) Root and tuber crops: potato (good sprouting, good growth, increase in harvest), konjac (increase in harvest).

(IV) Root vegetables: Japanese radish (good growth).

(V) Leafy/stem vegetables: chives (good sprouting, good taste), scallion (good growth).

(VI) Wild grapes (Used as an additional fertilizer. Good growth).

### Embodiment 9: Burning Tests for Shells Other than Scallops

Burning tests are performed on shells other than scallops in the similar conditions to the embodiment 1 and 2. Shells tested are oysters and corbiculas. Results are shown in Table 6 and 7. As shown in the tables, although there is a difference in pulverization characteristics in different variety of shellfish, any shell yields burnt materials with the specification of the carbonizing and ashing conditions of the present invention. Thus, it is shown that the method of the production of the present invention may be applied to shells other than scallops.

TABLE 6
Burning test of oyster shells.

| TEMPERATURE | OBSERVATION OF | EVALUATION OF |
|---|---|---|
| (° C.) | DEGENERATION | PULVERIZATION |
| 600 | Carbonized completely | Easily breakable by hand |
| 700 | | Tip parts become powdery |
| 800 | Whole surface becomes | Tips parts are pulverized |
| | ashed | |

TABLE 7
Burning test of corbicula shells

| TEMPERATURE | OBSERVATION OF | EVALUATION OF |
|---|---|---|
| (° C.) | DEGENERATION | PULVERIZATION |
| 600 | Carbonized completely | |
| 700 | | Easily breakable by hand |
| 800 | Surface slightly ashed | |

### INDUSTRIAL APPLICABILITY

Since the soil improving material derived from marine resources of the present invention and the process for producing the same are composed as described above, acid soil improvement by calcium carbonate may be carried out fast. Further, sowing of seed is possible on the same day of spraying because plant roots are not damaged, and workable days on the field, in particular, in cold areas may be extended very much longer. Still further, growth promoting and quality improving effects on plants may be obtained by the soil improving material derived from marine resources of the present invention.

1. A method for producing a soil improving material derived from marine resources, wherein the soil improving material comprises calcium carbonate existing separately from organic matrix, comprising the steps of:
burning shells of shellfish including scallops, oysters, corbiculas and the like, under burning conditions for degrading the organic matrix to such an extent that calcium carbonate may be separated from the organic matrix, said marine resources comprising calcium carbonate and organic matrix enclosing calcium carbonate as main components, and
pulverizing the burnt material obtained in said burning step to separate calcium carbonate therein;
said pulverizing step comprises crushing the burnt material mechanically and passing said resultant crashed material through a wire sieve of mesh size from 60 (250 micro meters) to 80 (177 micro meters), and,
said burning step is either (A) for carbonizing or (B) for ashing:
(A) said burning step is carried out under burning conditions comprises a burning temperature from 600 degrees Centigrade to 700 degrees Centigrade, and a burning time from 5 minutes to 20 minutes;
(B) said burning conditions comprises a burning temperature from 770° C. to 830° C., and a burning time from 25 minutes to 45 minutes, using natural gas for a fuel and a radiant heat furnace which are together capable of degrading calcium oxide generated in the step.

2. A soil improving material derived from marine resources which is capable of use on the very day of manufacture spreading without deleterious effect, characterized in that the soil improving material is produced by the method according to claim 1, with the burning step (A), the soil improving material contains calcium carbonate 98% by weight or more, alkali content from 50% to 60%, and particles with a diameter of 250 micro meters or less represents 90% to 100% by weight of the total weight.

3. A soil improving material derived from marine resources which is capable of use on the very day of manufacture spreading without deleterious effect, characterized in that the soil improving material is produced by the method according to claim 1 with the burning step (A), soil improving material contains calcium carbonate 70% by weight or more, alkali content from 60% to 65%, and particles with a diameter of 250 micro meters or less represents 90% to 100% by weight of the total weight.

4. The method for producing a soil improving material derived from marine resources according to claim 3, characterized in that said burning conditions comprises a burning temperature from 560° C. to 740° C., and a burning time from 3 minutes to 25 minutes.

5. The method for producing a soil improving material derived from marine resources according to claim 3, characterized in that said burning conditions comprises a burning temperature from 600° C. to 700° C., and a burning time from 5 minutes to 20 minutes.

6. The method for producing the soil improving material derived from marine resources according to claim 1, characterized in that said burning step is carried out under burning conditions for ashing said organic matrix, and in the burning step, a burnt material, which consists of undegraded calcium carbonate and ashed organic matrix, may be obtained.

7. The method for producing a soil improving material derived from marine resources according to claim 6, characterized in that said burning conditions comprises a burning temperature from 720° C. to 900° C., and a burning time from 25 minutes to 45 minutes.

8. The method for producing a soil improving material derived from marine resources according to claim 6, characterized in that the burning conditions comprises a burning temperature from 750° C. to 850° C., and a burning time from 25 minutes to 45 minutes.

9. The method for producing a soil improving material derived from marine resources according to claim 6, characterized in that said burning conditions comprises a burning temperature from 770° C. to 830° C., and a burning time from 25 minutes to 45 minutes.

10. The method for producing a soil improving material derived from marine resources according to claim 6, characterized in that said burning step comprises use of a fuel and a furnace which are together capable of degrading calcium oxide generated in the step.

11. The method for producing a soil improving material derived from marine resources according to claim 10, characterized in that said fuel is natural gas and said furnace is a radiant heat furnace.

12. The method for producing a soil improving material derived from marine resources according to claim 1, characterized in that said pulverizing step comprises crushing the burnt material mechanically and passing said resultant crashed material through a wire sieve of mesh size from 60 (250 μm) to 80 (177 μm).

13. A soil improving material derived from marine resources, characterized in that the soil improving material is produced by burning a raw material, and contains calcium carbonate of 98% by weight or more and alkali content from 50% to 60%, wherein said raw material is shells of shellfish including scallops, oysters, corbiculas and the like containing calcium carbonate and organic matrix enclosing calcium carbonate as main components.

14. A soil improving material derived from marine resources produced by the method according to claim 2, characterized in that the soil improving material contains calcium carbonate 98% by weight or more and alkali content from 50% to 60%.

15. A soil improving material derived from marine resources, which is produced by burning a raw material of shells of shellfish including scallops, oysters, corbiculas and the like containing calcium carbonate and organic matrix enclosing calcium carbonate as main components, characterized in that particles with a diameter of 250 μm or less represents 90 to 100% by weight of the total weight.

16. A soil improving material derived from marine resources produced by the method according to claim 2, characterized in that particles with a diameter of 250 μm or less represents 90 to 100% by weight of the total weight.
